(19) United States
(12) Patent Application Publication
(10) Pub. No.: US 2010/0293044 A1
(43) Pub. Date: Nov. 18, 2010

(54) INFORMATION TRANSMITTING APPARATUS AND INFORMATION DELIVERY SYSTEM

(75) Inventor: Takashi Kozai, Kanagawa (JP)

Correspondence Address: Seed Intellectual Property Law Group PLLC, 701 Fifth Avenue, Suite 5400, Seattle, WA, 98104, US

(73) Assignee: PANASONIC CORPORATION, Osaka (JP)

(21) Appl. No.: 12/863,430

(22) PCT Filed: Dec. 10, 2008
(86) PCT No.: PCT/JP2008/003701

§ 371 Date: Jul. 16, 2010

(30) Foreign Application Priority Data
Jan. 18, 2008 (JP) 2008-008875

(51) Int. Cl. G06Q 30/00

(52) U.S. Cl. 705/14.4

(57) ABSTRACT

In the case of deciding that a state of a communication band becomes insufficient in the sending side in a streaming system for delivering the contents and advertisement information, it is constructed so that the advertisement information suitable for the state can be selected and transmitted and also it can cope by changing a display method of the contents and the advertisement information in the receiving side. In the sending side, a method for creating transmitting data is changed according to a state of a communication channel. When there is a sufficient band in the communication channel, the transmitting data in which advertisement is inserted between divided pieces of information is generated and when the communication band is insufficient, the data in which the way of insertion is changed, for example, frequency of insertion of the advertisement information is shifted or only character information is inserted is generated. In the receiving side, the received data is analyzed and a layout is changed according to an analysis result. At the normal time, the advertisement information is displayed by the constant contents of display, but when the communication band is insufficient, a change in the layout for displaying a marquee part for displaying the advertisement information is made.

### TECHNICAL FIELD

The present invention relates to an information transmitting apparatus for transmitting advertisement information and the contents which are object information through a network, and a streaming system for delivering the advertisement information and the object information, the so-called information delivery system, and particularly to the information transmitting apparatus capable of changing a delivery method of the advertisement information according to a communication speed, the so-called band state of a communication channel, and the information delivery system using this information transmitting apparatus.

### BACKGROUND ART

Provision of advertisement information etc. together with object information has been commercialized as an information delivery system for providing the object information such as the contents through a network such as the Internet. By providing the advertisement information etc. together with the object information, a service to obtain an advertising rate from an advertisement information provider and provide the object information for a client at low cost can be done in the server side, so that there is a possibility that this provision method becomes widespread.

In addition, the advertisement information is generally shown in a form of being inserted into the object information regardless of client's taste or intention, so that the advertisement information is delivered in certain consideration so as not to offer a feeling of discomfort to the client. For example, when the advertisement information is reproduced during wait time for which the object information is downloaded, the wait time taken to end the download of the object information is predicted and the advertisement information completed by time corresponding to the wait time is selected and delivered. It is better for the client to see the advertisement information than to see an indicator showing a download state since the client is not bored. Also, since a shift to the object information is smoothly made when the advertisement information is ended, the information is not switched artificially and a viewer can stably see the information, so that some positive advertising effects are expected (for example, see Patent Reference 1).

Incidentally, streaming of moving image starts to become widespread by development of recent Internet technology. In the streaming for reproducing data simultaneously while receiving the data, reproduction is started as soon as the necessary data is received from a server to a client, so that there is an advantage that there is no wait time of download as described in the conventional art. Then, a function of dividing screen display of a mobile telephone terminal into two pieces and reproducing and outputting live video by streaming in real time on one screen and reproducing and displaying a caption, advertisement, etc. by character information or a still image on the other screen has also been proposed already. Sooner or later, it appears that a function of reproducing advertisement information about the moving image together with object information about the moving image is also proposed (for example, see Patent Reference 2).

Patent Reference 1: JP-A-2005-78173

Patent Reference 2: JP-A-2006-237673

### DISCLOSURE OF THE INVENTION

### Problems that the Invention is to Solve

In the case of delivering the advertisement information and the contents which are the object information by streaming, there is a problem of whether or not an available band has a speed or more necessary for the streaming. When there is a sufficient band in a communication channel, streaming reproduction can be performed without problems even in the case of inserting the advertisement information about moving image into the object information about the moving image and transmitting the information. However, when there is not the sufficient band in the communication channel, data delay, delay fluctuation or data loss by packet loss may occur. Then, data necessary for stream reproduction in the client is insufficient and viewing quality deterioration such as a break in communication, a pause or a frame jump of a moving image occurs. In extreme cases, the streaming reproduction may be performed intermittently.

Therefore, it is contemplated to measure a communication speed from the server to the client and select and deliver information about a quality grade available by a user based on the measured communication speed as one of measures. This is an idea of having only to eliminate the break in communication, the pause or the frame jump of the moving image even in the case of reducing the quality grade when there is not the sufficient band in the communication channel.

The invention advances this idea one step, and copes with a desire that the client wants to see only the object information soon with certain quality when the streaming reproduction starts to interrupt. That is, a first problem of the invention is to provide an information transmitting apparatus in which the communication speed from the server to the client is measured and when the measured communication speed is less than or equal to a threshold value, the advertisement information inserted into the object information is decreased and the frame jump etc. of the moving image are eliminated without reducing the quality grade of the object information.

Then, a second problem of the invention is to provide an information delivery system for changing a display layout of a display section according to the advertisement information received by an information receiving apparatus.

### Means for Solving the Problems

In the invention, an information transmitting apparatus includes: a storage section that stores first delivery information including object information related to a request of an information receiving apparatus and advertisement information inserted into the object information in a first period; a communication speed acquisition section that acquires a communication speed of a communication with the information receiving apparatus; a transmitting data generating section that generates second delivery information by modifying the first delivery information so as to insert the advertisement information into the object information in a second period when the communication speed is less than or equal to a threshold value; and a data transmitting section that streams the second delivery information to the information receiving apparatus through a network when the communication speed is less than or equal to the threshold value. Particularly, the second period is made longer than the first period.

By this configuration, when the communication speed is sufficient, the first delivery information in which the advertisement information is inserted into the object information in the first period can be delivered and when the communication speed is insufficient, the second delivery information in which the advertisement information is inserted in the second period longer than the first period can be delivered. Then, delivery in response to change in the communication speed is provided while keeping a quality grade of the object information.

Also, in the invention, the information transmitting apparatus includes: a storage section that stores first delivery information including object information related to a request of an information receiving apparatus and advertisement information inserted into the object information in a first format having a first data size; a communication speed acquisition section that acquires a communication speed of a communication with the information receiving apparatus; a transmitting data generating section that generates second delivery information by modifying the first delivery information so as to change the advertisement information from the first format to a second format having a second data size smaller than the first data size when the communication speed is less than or equal to a threshold value; and a data transmitting section that streams the second delivery information to the information receiving apparatus through a network when the communication speed is less than or equal to the threshold value.

By this configuration, when the communication speed is sufficient, the first delivery information in which the advertisement information with the first data size is inserted into the object information can be delivered and when the communication speed is insufficient, the second delivery information in which the advertisement information with the second data size smaller than the first data size is inserted can be delivered. Then, the delivery in response to change in the communication speed is provided while keeping the quality grade of the object information.

Also, in the invention, the information transmitting apparatus includes: a storage section that stores first delivery information including object information related to a request of an information receiving apparatus and advertisement information inserted into the object information, the advertisement information having a first time length; a communication speed acquisition section that acquires a communication speed of a communication with the information receiving apparatus; a transmitting data generating section that generates second delivery information by modifying the first delivery information so as to reduce a time length of the advertisement information from the first time length to a second time length when the communication speed is less than or equal to a threshold value; and a data transmitting section that streams the second delivery information to the information receiving apparatus through a network when the communication speed is less than or equal to the threshold value.

By this configuration, when the communication speed is sufficient, the first delivery information in which the advertisement information having the first time length is inserted into the object information can be delivered and when the communication speed is insufficient, the second delivery information in which the advertisement information having the second time length reduced from the first time length is inserted can be delivered. Then, the delivery in response to change in the communication speed is provided while keeping the quality grade of the object information.

Also, in the invention, an information delivery system has an information transmitting apparatus and an information receiving apparatus connected to the information transmitting apparatus through a communication channel, wherein the information receiving apparatus includes: a data receiving section that receives the second delivery information streamed from the information transmitting apparatus; a layout change section that changes a layout of the second delivery information to generate display information; and a display section that displays the display information.

By this configuration, the advertisement information received by the information receiving apparatus can be displayed by an easy-to-see layout according to quality of the advertisement information.

### ADVANTAGE OF THE INVENTION

In the information transmitting apparatus of the invention, when a state of the communication channel is insufficient and a sending speed is slow, for example, the period in which the advertisement information is inserted is increased or the data size of the inserted advertisement information is decreased or the time length of the inserted advertisement information is shortened, and the transmitting data with less advertisement information can be generated and transmitted.

For example, as to the data size of the advertisement information, the advertisement information about the moving image is inserted into the object information about the moving image and is transmitted when there is a sufficient band in the communication channel. When there is not the sufficient band in the communication channel, the advertisement information about a still image is uniformly inserted into the object information about the moving image and is transmitted. Or, the advertisement information including only a character is uniformly inserted into the object information about the moving image and is transmitted. Thus, the data size of the advertisement information, that is, the quality grade of the advertisement information can be selected to send the data according to the state of the communication channel.

As a result, in the case of becoming a radio wave state in which streaming reproduction interrupts, the data size of the advertisement information is decreased and the amount of the advertisement information is decreased and the object information can speedily be shown to a client with certain quality.

Also, in the information delivery system of the invention, a layout of the display section can be changed according to the advertisement information received by the information receiving apparatus. As a result, for example, when the advertisement information about only a character is received, a marquee display is performed in the corner of a display screen of the object information and the advertisement information can be shown in a small display area.

### BRIEF DESCRIPTION OF THE DRAWINGS

FIG. 1 is a system diagram of an information delivery system according to a first embodiment of the invention.

FIG. 2 is a diagram schematically showing a configuration of transmitting data stored in a storage section of the information delivery system according to the first embodiment of the invention.

FIG. 3 is an outline diagram of an information receiving apparatus of the information delivery system according to the first embodiment of the invention.

FIG. 4 is a front diagram of a display part of the information receiving apparatus of the information delivery system according to the first embodiment of the invention.

FIG. 5 is a timing chart of the information delivery system according to the first embodiment of the invention.

FIG. 6 is a flowchart showing an operation of CM decision processing of the information delivery system according to the first embodiment of the invention.

FIG. 7 is a flowchart showing an operation of another CM decision processing of the information delivery system according to the first embodiment of the invention.

FIG. 8 is a flowchart showing an operation of further CM decision processing of the information delivery system according to the first embodiment of the invention.

FIG. 9 is a transition diagram of the display part of the information receiving apparatus of the information delivery system according to the first embodiment of the invention.

### DESCRIPTION OF REFERENCE NUMERALS AND SIGNS

100 INFORMATION TRANSMITTING APPARATUS
101 OBJECT INFORMATION STORAGE SECTION
102 ADVERTISEMENT INFORMATION STORAGE SECTION
103 TRANSMITTING DATA GENERATING SECTION
104 INFORMATION DIVISION SECTION
105 STORAGE SECTION
106 DATA TRANSMITTING SECTION
107 COMMUNICATION SPEED ACQUISITION SECTION
108 SENDING APPARATUS CONTROL SECTION
200 INFORMATION RECEIVING APPARATUS
201 DATA RECEIVING SECTION
202 RECEIVED DATA ANALYSIS SECTION
203 LAYOUT CHANGE SECTION
204 DISPLAY SECTION

### BEST MODE FOR CARRYING OUT THE INVENTION

The best mode for carrying out the invention will hereinafter be described along with the drawings.

### First Embodiment

An information delivery system according to a first embodiment of the invention includes an information transmitting apparatus 100, plural information receiving apparatuses 200, 200a, etc., and a communication channel 300 for connecting both of the information transmitting apparatus and the information receiving apparatuses. Object information is transmitted from the information transmitting apparatus 100 to the plural information receiving apparatuses 200, 200a, etc. through the communication channel 300 in a form of inserting advertisement information into the object information.

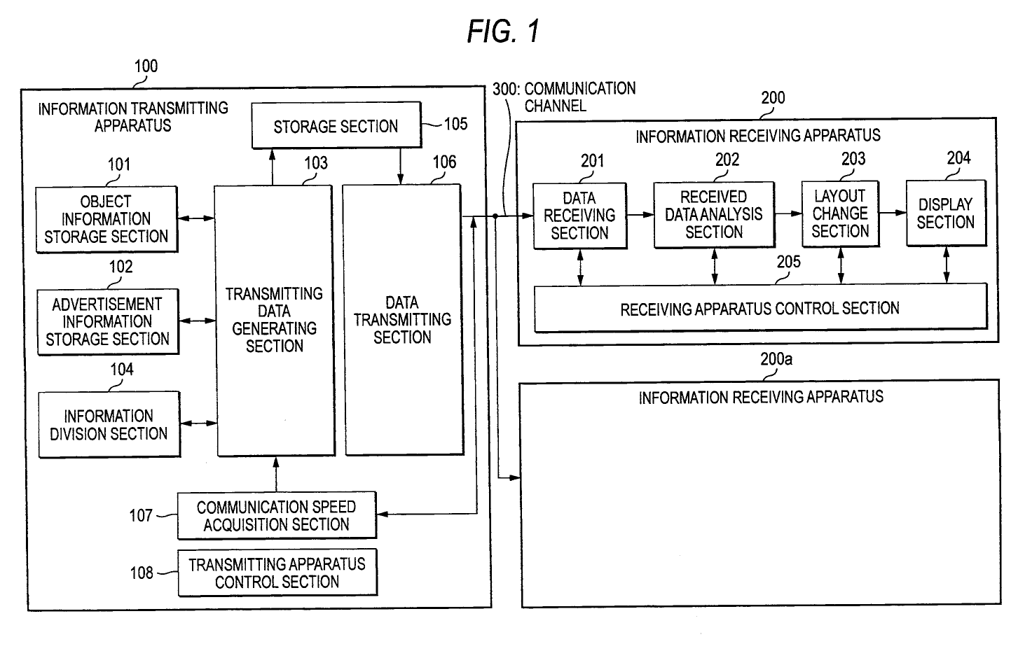

FIG. 1 shows a block diagram of the information delivery system according to the first embodiment of the invention. In FIG. 1, the object information and the advertisement information are respectively transmitted from the information transmitting apparatus 100 to plural information receiving apparatuses such as the plural information receiving apparatuses 200, 200a through the communication channel 300.

In the information delivery system of the invention, the information transmitting apparatus 100 is connected to the plural information receiving apparatuses 200, 200a, etc., but in FIG. 1, only the two information receiving apparatuses are shown for the sake of simplicity.

The case of sending the object information and the advertisement information from the information transmitting apparatus 100 to the information receiving apparatus 200 through the communication channel 300 as transmitting data will hereinafter be described, but basic configuration and operation are the same also in the case of sending the information from the information transmitting apparatus 100 to the other information receiving apparatuses 200a, etc. A detailed block of the inside of the information receiving apparatus 200 is shown, but the inside of the information receiving apparatus 200a is the same as that of the information receiving apparatus 200, so that the mention is omitted.

The information transmitting apparatus 100 includes an object information storage section 101, an advertisement information storage section 102, a transmitting data generating section 103, an information division section 104, a storage section 105, a data transmitting section 106, a communication speed acquisition section 107 and a transmitting apparatus control section 108.

The object information storage section 101 is a storage device, and accumulates contents information which is the object information to be transmitted. The object information is moving image information, still image information, character information, sound information or information obtained by combining these. However, the object information accumulates information about one form as one contents, and when contents delivery is requested, the object information is read out of the object information storage section 101 and is delivered as the information about one form.

The advertisement information storage section 102 is similarly a storage device, and accumulates advertisement information transmitted and inserted into the object information, the so-called commercial information (CM information). The advertisement information is moving image information, still image information, character information, sound information or information obtained by combining these. The advertisement information about plural forms of the moving image information, the still image information, the character information, the sound information or the information obtained by combining these in one advertisement is accumulated in the advertisement information storage section 102. Then, one piece of advertisement information is selected from among the advertisement information about the plural forms and is delivered in a form of being inserted into the object information.

In addition, the object information and the advertisement information are respectively accumulated in the object information storage section 101 and the advertisement information storage section 102 as data of a play list format. In addition, explanation of a data structure of the play list format is omitted.

The transmitting data generating section 103 combines the object information accumulated in the object information storage section 101 with the advertisement information accumulated in the advertisement information storage section 102 and generates transmitting data. The transmitting data generating section 103 performs functions of two steps. That is, as the function of the first step, a play list of the transmitting data is generated by inserting a play list of the advertisement information inserted into the object information into a play list of the object information to be transmitted. Then, as the function of the second step, the object information and the advertisement information themselves corresponding to the play list of the transmitting data generated in the first step are sequentially read out of the object information storage section 101 or the advertisement information storage section 102 and the transmitting data is generated. In addition, creation of the play list of the transmitting data is omitted and the object information and the advertisement information themselves may be sequentially read out of the object information storage section 101 or the advertisement information storage section 102 and the transmitting data may be generated.

The information division section 104 is used for dividing one piece of object information at predetermined timing in the case of creating the transmitting data, and functions as an auxiliary unit of the transmitting data generating section 103. There are the plural timings at which the one piece of object information is divided, and the object information is divided at intervals of, for example, 30 minutes, 15 minutes or 5 minutes and the advertisement information is inserted into the object information.

The transmitting data generated by the transmitting data generating section 103 is accumulated in the storage section 105. The transmitting data accumulated in the storage section 105 is transmitted to the information receiving apparatus 200 through the communication channel 300 by the data transmitting section 106 as delivery information.

The communication speed acquisition section 107 monitors a state of the communication channel 300 extending to the information receiving apparatus 200 which is a sending destination and the information transmitting apparatus 100, and obtains a communication speed. A method for acquiring the communication speed includes a method for measuring the communication speed from the information transmitting apparatus 100 to the information receiving apparatus 200. Time for which the information transmitting apparatus 100 sends data and an ACK signal of data reception is transmitted from the information receiving apparatus 200 is observed. When the ACK signal is transmitted from the information receiving apparatus 200 as soon as the information transmitting apparatus 100 sends the data, the communication speed is fast, and when it takes time to send the ACK signal from the information receiving apparatus 200 though the data is transmitted, the communication speed is slow. In addition, in the invention, a threshold value of the communication speed is preset and it is decided that the communication speed is slow when the communication speed is less than or equal to the threshold value.

Also, the method for acquiring the communication speed includes a method for observing frequency of resending of information. This is the method for observing the frequency of resending of the same information when the information cannot be transmitted correctly though the information is transmitted. When resending is performed one time, the same information is transmitted two times. For example, when an ideal band is 5 Mbps as a state of the communication channel 300, the same information is transmitted two times when the resending is performed one time, and an effective value of the band becomes 2.5 Mbps, that is, half 5 Mbps.

When the communication speed acquisition section 107 acquires the communication speed and determines that the communication speed is less than or equal to the threshold value and a sufficient band is not obtained in a radio wave state of the communication channel 300, the transmitting data generating section 103 changes a method for creating the play list of the transmitting data which is the function of the first step. In addition, a method for reflecting the radio wave state of the communication channel 300 on the play list of the transmitting data includes a method for previously creating a first play list at the time when the sufficient band is obtained in the radio wave state of the communication channel 300 and making a modification according to the radio wave state of the communication channel 300 and remaking the first play list into a second play list, but a method for generating a play list to be transmitted every time according to the radio wave state of the communication channel 300 without previously creating the first play list may be used.

The transmitting apparatus control section 108 controls each of the sections described above and a communication section (not shown) etc. In addition, illustration of a state of connection between the transmitting apparatus control section 108 and other sections is omitted in order to simplify explanation.

In the communication channel 300, the transmitting data including the object information and the advertisement information is transmitted from the information transmitting apparatus 100 to the information receiving apparatus 200. In the communication channel 300, both of wired and wireless forms may be used, and every communication method is applicable.

The information receiving apparatus 200 includes a data receiving section 201, a received data analysis section 202, a layout change section 203, a display section 204, and a receiving apparatus control section 205. The data receiving section 201 receives the transmitting data transmitted from the information transmitting apparatus 100 as received data, and the received data analysis section 202 analyzes the contents of the received data. The layout change section 203 changes a layout displayed on the display section 204 according to the contents of the received data. The display section 204 displays the object information and the advertisement information from the received data after the layout is changed by the layout change section 203. In addition, when sound information is included in the object information and the advertisement information, a sound is output by a sound output section (not shown). The receiving apparatus control section 205 is connected to each of the sections described above and the communication section (not shown) etc., and controls these sections. In addition, the received data analysis section 202 may be constructed integrally with the layout change section 203.

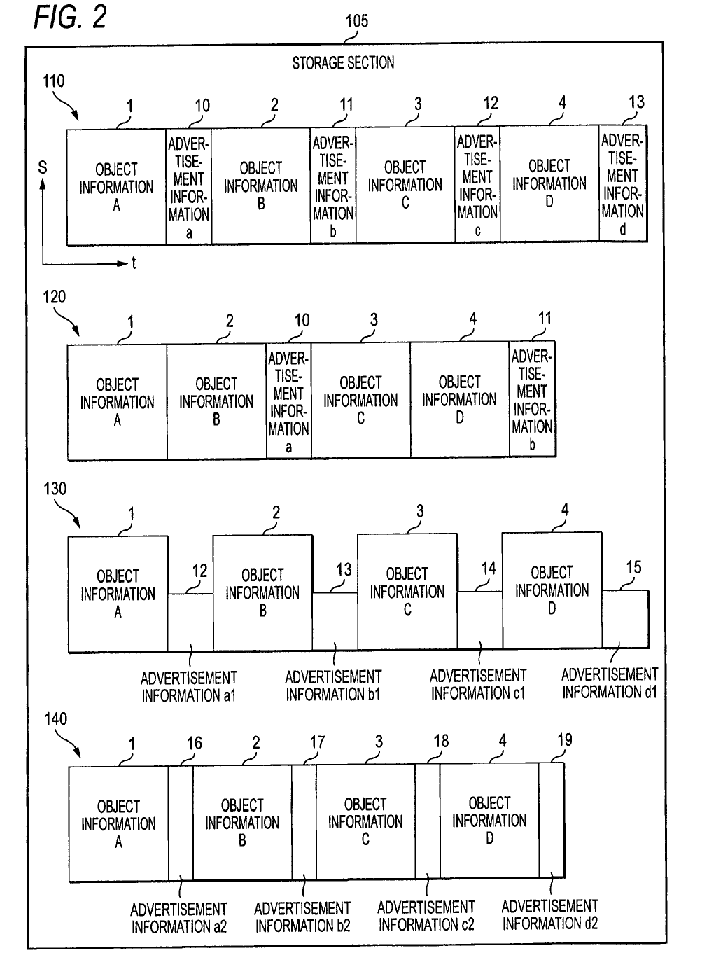

FIG. 2 schematically shows a configuration of the transmitting data stored in the storage section 105, that is, delivery information. In FIG. 2, each of the transmitting data is shown using the X axis as the time axis and the Y axis as a data size. The object information and the advertisement information are connected in a strip shape and form one transmitting data.

The transmitting data 110 shown in the top of FIG. 2 is the transmitting data transmitted at the time when the radio wave state of the communication channel 300 is good and the sufficient band is obtained and the communication speed is fast. The object information is divided into four pieces of object information A, object information B, object information C and object information D by the information division section 104 described already. Then, advertisement information a is inserted between the object information A and the object information B, and advertisement information b is inserted between the object information B and the object information C, and advertisement information c is inserted between the object information C and the object information D, respectively. Advertisement information d follows the object information D.

The transmitting data 120 shown in the second line from the top of FIG. 2 is transmitted at the time when the radio wave state of the communication channel 300 is bad and the sufficient band is not obtained and the communication speed is slow. A period in which the advertisement information is inserted is made longer than that of the transmitting data 110 at the time when the radio wave state of the communication channel 300 is good. Concretely, though the advertisement information is respectively inserted between the four pieces of object information divided in the transmitting data 110, one piece of advertisement information is inserted after two pieces of object information divided into four pieces are continued.

When the radio wave state of the communication channel 300 becomes bad, the transmitting data 110 stored as first delivery information is modified as shown in the transmitting data 120 and second delivery information is generated. Then, the data transmitting section 106 streams and delivers the second delivery information 120.

Also, the transmitting data 130 shown in the third line from the top of FIG. 2 is another example of the transmitting data transmitted at the time when the radio wave state of the communication channel 300 is bad and the sufficient band is not obtained and the communication speed is slow. In the transmitting data 130, the period in which the advertisement information is inserted is not changed and a format of the advertisement information is formed in a format of a small data size. For example, in the case of inserting the advertisement information about an moving image format as the first delivery information, the format of the advertisement information can be formed in the format of the small data size when the transmitting data is generated using the advertisement information about any format of character data, a still image and a sound instead of the advertisement information about the moving image format.

Also, the transmitting data 140 shown in the fourth line from the top of FIG. 2 is another example of the transmitting data transmitted at the time when the radio wave state of the communication channel 300 is bad and the sufficient band is not obtained and the communication speed is slow. In the transmitting data 140, the period in which the advertisement information is inserted is not changed and a time length of the advertisement information is reduced.

When the radio wave state of the communication channel 300 becomes bad, the transmitting data 110 stored as the first delivery information is modified as shown in the transmitting data 130, 140 and the second delivery information may be generated. The data transmitting section 106 streams and delivers the second delivery information.

In all the transmitting data 120, 130, 140 described above, the amount of advertisement information is made smaller than that of the transmitting data 110 stored as the first delivery information without changing the amount of object information. As a result, even when the radio wave state becomes intermittent, a sending density of the object information increases, so that an effect capable of speedily sending the object information is obtained.

In addition, as to which of the method for changing the period in which the advertisement information is inserted, the method for decreasing the data size of the advertisement information and the method for reducing the time length of the advertisement information when the radio wave state becomes bad is adopted, one of the methods may be adopted to create the transmitting data or the methods may be combined to create the transmitting data. Also, the case of modifying the first delivery information and creating the second delivery information is described above, but the second delivery information may be generated separately without changing the first delivery information when a storage capacity of the storage section 105 is sufficient.

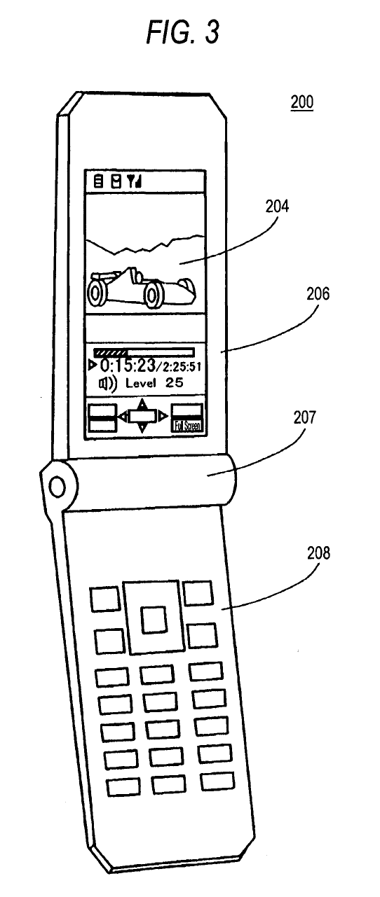

FIG. 3 shows an outline diagram of the information receiving apparatus 200 of the information delivery system according to the first embodiment of the invention. The case of applying the information receiving apparatus 200 to a folding mobile telephone unit will be described herein. An upper cabinet 206 of the information receiving apparatus 200 has the display section 204 and is joined to a lower cabinet 208 openably and closably by a hinge part 207. The data receiving section 201, the received data analysis section 202, the layout change section 203 and the receiving apparatus control section 205 (not shown) are accommodated in the lower cabinet 208.

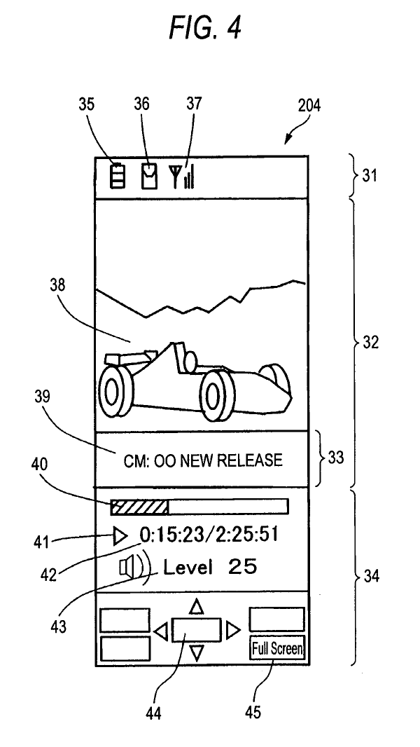

FIG. 4 shows a front diagram of the display section 204 of the information receiving apparatus 200 according to the first embodiment of the invention. A layout of the contents of display will be described simply using FIG. 4. Three display areas are broadly arranged on the display section 204 of the information receiving apparatus 200 of the invention

The first display area is an apparatus state display area 31 of the information receiving apparatus 200, and is arranged on the top of the display section 204. A battery icon 35 for displaying a charging state of a charging battery, a mail icon 36 indicating that there is incoming unread electronic mail, an antenna icon 37 indicating electric field intensity of radio waves, etc. are displayed in the apparatus state display area 31.

The second display area is a moving image display area 32 in which object information about the moving image is displayed, and the moving image of a DVD (Digital Versatile Disc) delivered on demand or television broadcast is displayed. The moving image display area 32 is arranged just under the apparatus state display area 31 described above. In addition, in a part of the moving image display area 32, an area is shortened up and down and is decreased by layout change and the shortened area is used as a telop display area 33 in which advertisement information including character information is displayed.

The third display area is a manipulation state display area 34, and an moving image reproduction indicator 40, an operation mark 41, reproduction time 42, a sound level 43, content display 44, 45 of a soft keyboard, etc. are displayed. The manipulation state display area 34 is arranged on the bottom of the display section 204.

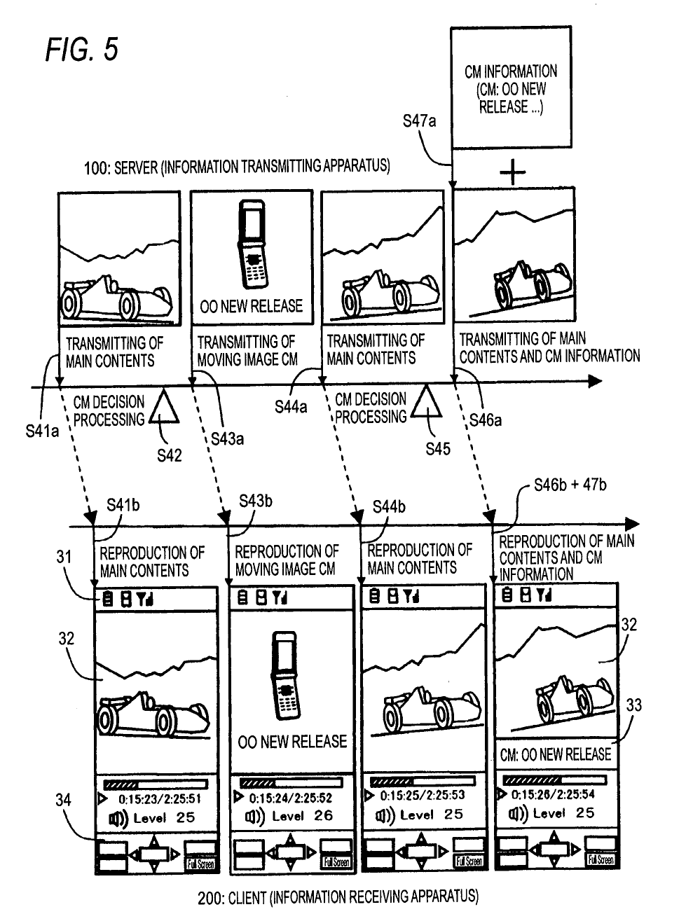

FIG. 5 shows an operation of the information delivery system according to the first embodiment of the invention as a timing chart. In explanation of FIG. 5, the operation using the information transmitting apparatus 100 as a “server” is shown in the upper half of FIG. 5 and the operation using the information receiving apparatus 200 as a “client” is shown in the lower half of FIG. 5. Two horizontal arrows shown in FIG. 5 show the time axes, and indicate that the operation proceeds in a left direction to a right direction. Longitudinal arrows show the respective operations and operation step numbers are assigned to the longitudinal arrows. Diagonal arrows of broken lines show correspondence relations between each of the operations.

When object information is first requested from the information receiving apparatus 200 of the client, the information transmitting apparatus 100 of the server sends the main contents which are the object information, moving image of a racing car in FIG. 5 (S41a). The information receiving apparatus 200 of the client reproduces the received main contents in the moving image display area 32 of the display section 204 (S41b). Thereafter, the communication speed acquisition section 107 of the information transmitting apparatus 100 observes a state of the communication channel 300 during sending of the main contents and decides a communication speed (S42). When the communication speed acquisition section 107 of the information transmitting apparatus 100 decides that a band of the communication channel 300 is sufficient, the transmitting data generating section 103 of the information transmitting apparatus 100 reads advertisement information about the moving image out of the advertisement information storage section 102 and creates transmitting data and retains the transmitting data in the storage section 105. The advertisement information about the moving image is transmitted to the information receiving apparatus 200 of the client via the communication channel 300 by the data transmitting section 106 (S43a).

The information receiving apparatus 200 of the client receives the advertisement information by the data receiving section 201, and the received data analysis section 202 determines whether the advertisement information is moving image, a still image, character information or combination thereof. When the advertisement information is the moving image, the advertisement information is reproduced in the moving image display area 32 of the display section 204 (S43b). Thereafter, when the main contents are transmitted (S44a) and reproduction of the advertisement information is ended, the main contents are reproduced in the moving image display area 32 (S44b).

Thereafter, the communication speed acquisition section 107 of the information transmitting apparatus 100 of the server observes the state of the communication channel 300 during sending of the main contents and decides the communication speed (S45). When the communication speed acquisition section 107 of the information transmitting apparatus 100 decides that the band of the communication channel 300 is not sufficient, the transmitting data generating section 103 of the information transmitting apparatus 100 reads object information following the main contents out of the object information storage section 101 (S46a) and also reads, for example, advertisement information about only character information out of the advertisement information storage section 102 and creates transmitting data and retains the transmitting data in the storage section 105 (S47a). The data transmitting section 106 of the server sends out the object information following the main contents and the advertisement information about only the character information to the client via the communication channel 300.

The information receiving apparatus 200 receives the advertisement information by the data receiving section 201, and the received data analysis section 202 determines whether the advertisement information is moving image, a still image, character information or combination thereof. When the advertisement information is the character information, a layout change in which a layout of the moving image display area 32 of the display section 204 is shortened up and down and the shortened area is set in the telop display area 33 is made. Then, the moving image of the main contents is displayed in the shortened moving image display area (S46b) and the advertisement information about the character information is displayed in the telop display area 33 (S47b). In addition, when reproduction of the advertisement information is ended, a size of the moving image display area 32 returns to the original size and the main contents are reproduced (not shown).

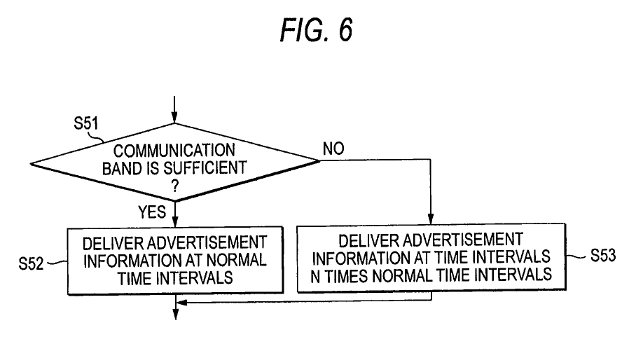

FIGS. 6 to 8 show flowcharts of processing in which the communication speed acquisition section 106 of the information transmitting apparatus 100 observes the state of the communication channel 300 during sending of the main contents and decides a quality grade of the transmitted advertisement information, the so-called “CM decision processing”.

FIG. 6 shows the flowchart of CM decision processing for changing a period in which the advertisement information is inserted according to a state of a band of the communication channel 300. In the CM decision processing, the communication speed acquisition section 107 of the information transmitting apparatus 100 of the server observes the state of the communication channel 300 during sending of the main contents and decides whether or not the band is sufficient (S51). When the band is sufficient (Yes of S51), processing for delivering the advertisement information in a normal period, that is, at predetermined time intervals is performed (S52). When the band is not sufficient (No of S51), processing for delivering the advertisement information at the time intervals N times, for example, two times the normal period is performed (S53). Consequently, when the state of the communication channel 300 is bad and the band is not sufficient, the object information is exclusively delivered and can be provided in a form of suppressing delivery of the advertisement information.

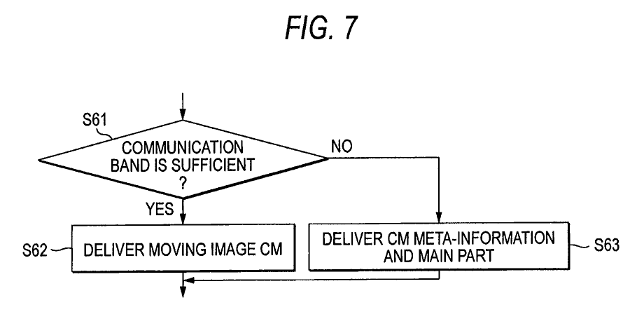

FIG. 7 shows the flowchart of CM decision processing for changing a data size of the advertisement information inserted according to the state of the band of the communication channel 300. The communication speed acquisition section 107 of the information transmitting apparatus 100 of the server observes the state of the communication channel 300 during sending of the main contents and decides whether or not the band is sufficient (S61). When the band is sufficient (Yes of S61), processing for selecting and delivering the advertisement information about the moving image is performed (S62). When the band is not sufficient (No of S61), processing for selecting and delivering the advertisement information about character information, for example, CM meta-information together with the object information about the moving image of the main contents is performed (S63). Consequently, every time the state of the communication channel 300 is observed, the advertisement information with the data size corresponding to the state of the band can be selected and provided.

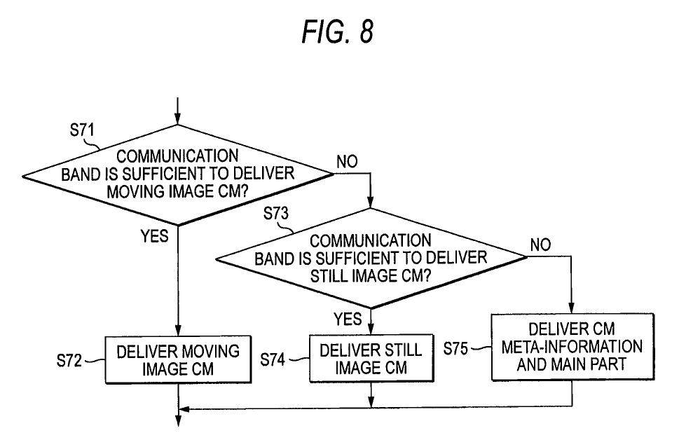

FIG. 8 shows the flowchart of CM decision processing for previously accumulating three pieces of advertisement information about the moving image, a still image and character information with different data sizes in the advertisement information storage section 102 as the advertisement information and determining the state of the band of the communication channel 300 in three stages and selecting and delivering any advertisement information according to the state of the band. In FIG. 8, the communication speed acquisition section 107 of the information transmitting apparatus 100 of the server observes the state of the communication channel 300 during sending of the main contents and decides whether or not the band is sufficient to deliver the advertisement information about the moving image (S71). When the band is sufficient (Yes of S71), processing for delivering the advertisement information about the moving image is performed (S72). When the band is not sufficient to deliver the advertisement information about the moving image but is sufficient to deliver the advertisement information about the still image (Yes of S73), processing for delivering the advertisement information about the still image is performed (S74). When the band is not sufficient to deliver both of the advertisement information about the moving image and the advertisement information about the still image (No of S73), processing for selecting and delivering the advertisement information about the character information, for example, CM meta-information together with the object information about the moving image of the main contents is performed (S75). Consequently, the three pieces of advertisement information about the moving image, the still image and the character information can properly be used according to the state of the communication channel 300 to provide the advertisement information.

Here, the three flowcharts of FIGS. 6, 7 and 8 are described individually, but a new method for combining these flowcharts and delivering the advertisement information may be adopted.

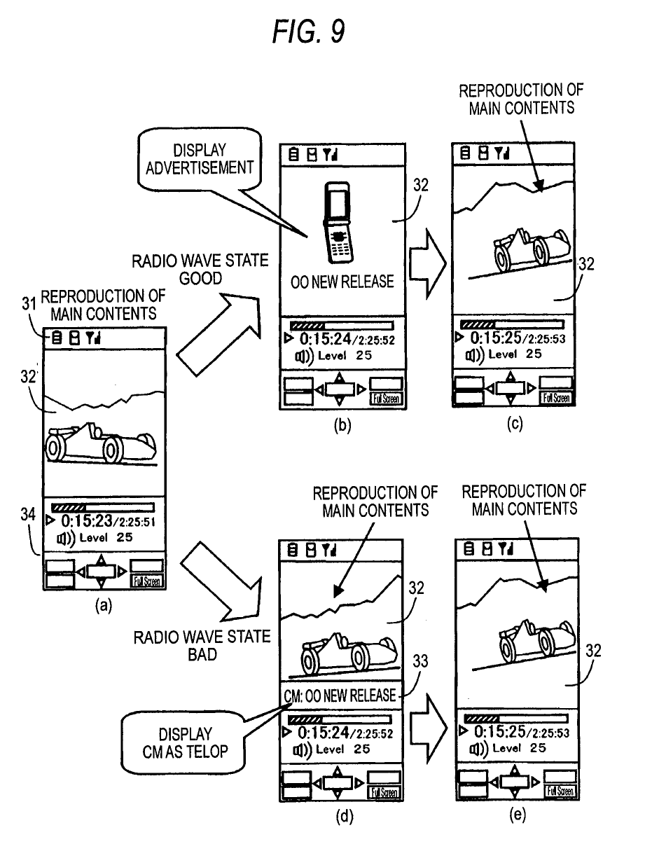

FIG. 9 shows transition of a display operation of the display section 204 of the information receiving apparatus 200 according to the first embodiment of the invention as a transition diagram. FIG. 9(a) shows a screen at the time when the information receiving apparatus 200 of the client makes a request and the received main contents are reproduced in the moving image display area 32 of the display section 204. When a radio wave state is good in the case of displaying the moving image in FIG. 9(a), advertisement information about the moving image is delivered. When the received data analysis section 202 of the client determines that the received advertisement information about the moving image is the moving image, the advertisement information about the moving image is reproduced in the moving image display area 32 without changing a layout of the display section 204 as shown in FIG. 9(b). When the radio wave state is good thus, the advertisement information is displayed as the moving image as shown in FIG. 9(b). FIG. 9(b) shows a situation in which the advertisement information including a moving image video of the mobile telephone unit and a character of “OO new release” is displayed and a sound of advertisement is output by an output section (not shown). Then, when reproduction of the advertisement information about the moving image is ended, the moving image of the main contents is reproduced in the moving image display area 32 as shown in FIG. 9(c).

On the other hand, when the radio wave state is bad in the case of displaying the moving image in FIG. 9(a), the advertisement information about only character information is delivered together with the main contents. When the received data analysis section 202 of the client determines that the received advertisement information about the moving image is the character information, a layout of the display section 204 is changed as shown in FIG. 9(d). Concretely, a size of the moving image display area 32 is shortened up and down and is decreased and the advertisement information about the character information is reproduced in the shortened place as the telop. When the radio wave state is bad thus, the advertisement information normally displayed as the moving image is displayed as the telop as shown in FIG. 9(d). In FIG. 9(d), display of the advertisement information is superimposed on display of the main contents on the display section 204.

In addition, in a character displayed as the telop, the advertisement information previously accumulated in the advertisement information storage section 102 as the character information may be displayed, or a sponsor name or a title of the advertisement information about the moving image, for example, “OO new release” or “□Δ corporation” may be displayed using metadata indicating an attribute of the advertisement information. Use of the metadata has an advantage of saving time and effort to previously accumulate the advertisement information about the character information separately from the advertisement information about the moving image.

When reproduction of the advertisement information about the character information is ended, the layout of the display section 204 is returned to the original layout and the moving image of the main contents is reproduced in the moving image display area 32 whose size returns to the original size as shown in FIG. 9(e).

In the information receiving apparatus 200 of the client thus, the data receiving section 201 receives the object information and the advertisement information, and the received data analysis section 202 determines whether the advertisement information is the moving image, the still image or the character information. When the advertisement information is the character information, the layout change in which the moving image display area 32 of the display section 204 is decreased and the narrowed place of the moving image display area 32 is set in the telop display area 33 is made. Then, the object information following the main contents is displayed in the decreased moving image display area 32 and the advertisement information about only the character information is displayed in the telop display area 33.

When the radio wave state becomes bad and the advertisement information replaced with the moving image of the main contents displayed on the large screen becomes the advertisement information about only the character information with a small amount of information, the invention can continuously display the moving image of the main contents and display the telop in the corner of the moving image, so that easy-to-see screen display without offering a feeling of complication or a feeling of discomfort can be provided for the client.

The present application is based on Japanese patent application (patent application No. 2008-008875) filed on Jan. 18, 2008, and the contents of the patent application are hereby incorporated by reference.

Various embodiments of the invention have been described above, but the invention is not limited to the matters shown in the embodiments described above, and the invention intends that persons skilled in the art make changes and applications of the matters based on the well-known art and mention of the description, and the changes and applications are included in the scope of protection.

### INDUSTRIAL APPLICABILITY

The invention can be applied to an information transmitting apparatus for delivering object information and advertisement information through a network and a streaming system, the so-called information delivery system. The information transmitting apparatus corresponds to a server connected to the network, and an information receiving apparatus corresponds to a client connected to the network.

The network can be applied to a wireless network using a mobile telephone network such as the so-called i-mode in addition to a wired network of the Internet.

1. An information transmitting apparatus comprising:
a storage section that stores first delivery information including object information related to a request of an information receiving apparatus and advertisement information inserted into the object information in a first period;
a communication speed acquisition section that acquires a communication speed of a communication with the information receiving apparatus;
a transmitting data generating section that generates second delivery information by modifying the first delivery information so as to insert the advertisement information into the object information in a second period when the communication speed is less than or equal to a threshold value; and
a data transmitting section that streams the second delivery information to the information receiving apparatus through a network when the communication speed is less than or equal to the threshold value.

2. The information transmitting apparatus according to claim 1, wherein the second period is longer than the first period.

3. An information transmitting apparatus comprising:
a storage section that stores first delivery information including object information related to a request of an information receiving apparatus and advertisement information inserted into the object information in a first format having a first data size;
a communication speed acquisition section that acquires a communication speed of a communication with the information receiving apparatus;
a transmitting data generating section that generates second delivery information by modifying the first delivery information so as to change the advertisement information from the first format to a second format having a second data size smaller than the first data size when the communication speed is less than or equal to a threshold value; and
a data transmitting section that streams the second delivery information to the information receiving apparatus through a network when the communication speed is less than or equal to the threshold value.

4. The information transmitting apparatus according to claim 3, wherein the first format is a moving image format and the second format is any one of character data, a still image and a sound.

5. An information transmitting apparatus comprising:
a storage section that stores first delivery information including object information related to a request of an information receiving apparatus and advertisement information inserted into the object information, the advertisement information having a first time length;
a communication speed acquisition section that acquires a communication speed of a communication with the information receiving apparatus;
a transmitting data generating section that generates second delivery information by modifying the first delivery information so as to reduce a time length of the advertisement information from the first time length to a second time length when the communication speed is less than or equal to a threshold value; and
a data transmitting section that streams the second delivery information to the information receiving apparatus through a network when the communication speed is less than or equal to the threshold value.

6. An information delivery system having an information transmitting apparatus as set forth in claim 1, and an information receiving apparatus connected to the information transmitting apparatus through a communication channel,
wherein the information receiving apparatus includes:
a data receiving section that receives the second delivery information streamed from the information transmitting apparatus;
a layout change section that changes a layout of the second delivery information to generate display information; and
a display section that displays the display information
